(19) United States
(12) Patent Application Publication
(10) Pub. No.: US 2016/0302394 A1
(43) Pub. Date: Oct. 20, 2016

(54) Poultry Feeder System and Method

(71) Applicant: Jeff A. Bergquist, Wilmington, IL (US)

(72) Inventor: Jeff A. Bergquist, Wilmington, IL (US)

(21) Appl. No.: 15/132,226

(22) Filed: Apr. 18, 2016

Related U.S. Application Data
(60) Provisional application No. 62/148,405, filed on Apr. 16, 2015.

(51) Int. Cl. A01K 39/012; A01K 39/014

(52) U.S. Cl. CPC A01K 39/012; A01K 39/014

(57) ABSTRACT

A system and method for feeding poultry are disclosed. The system may include a bucket, a cover configured to removably seal the top of the bucket, a plurality of openings on the bottom of the bucket; and a plurality of arced pipes extending from the openings at the bottom past the sides of the bucket. The method may include the steps of drilling an opening in a housing; placing first elbows in the housing; securing second elbows to the housing; placing spacers on the second elbows; forming a dispersion floor; placing the dispersion floor in the housing; filling the housing with feed; and placing the housing amongst poultry.

### CROSS REFERENCE TO RELATED APLICATION

This application claims the benefit of U.S. Provisional Application No. 62/148,405, filed Apr. 16, 2015, which is entirely incorporated herein by reference.

### BACKGROUND

1. Field

This invention is generally related to poultry systems and methods, and more particularly to a system and method for feeding poultry using a bucket and tubes.

2. Background

Systems and methods for feeding poultry have been around for thousands of years. However, the industry is in need of a more efficient and convenient system and method for feeding poultry.

### SUMMARY

Disclosed herein is a new and improved system and method for feeding poultry. In accordance with one aspect of the approach, a system for feeding poultry may include a bucket, a cover configured to removably seal the top of the bucket, a plurality of openings on the bottom of the bucket, and a plurality of arced pipes extending from the openings at the bottom past the sides of the bucket.

In accordance with a method of deeding poultry, the method may include the steps of drilling an opening in a housing; placing first elbows in the housing; securing second elbows to the housing; placing spacers on the second elbows; forming a dispersion floor; placing the dispersion floor in the housing; filling the housing with feed; and placing the housing amongst poultry.

Other systems, methods, aspects, features, embodiments and advantages of the system and method disclosed herein will be, or will become, apparent to one having ordinary skill in the art upon examination of the following drawings and detailed description. It is intended that all such additional systems, methods, aspects, features, embodiments and advantages be included within this description, and be within the scope of the accompanying claims.

### BRIEF DESCRIPTION OF THE DRAWINGS

It is to be understood that the drawings are solely for purpose of illustration. Furthermore, the components in the figures are not necessarily to scale, emphasis instead being placed upon illustrating the principles of the system disclosed herein. In the figures, like reference numerals designate corresponding parts throughout the different views.

FIG. 1 is an angled view of a poultry feeding system with a housing, a lid, and with portions of three feed access spouts shown.

FIG. 2 is a top view of the poultry feeding system of FIG. 1 without the lid.

FIG. 3 is a side view of a second exemplary poultry feeding system having feed in the housing and with two feed access spouts shown.

FIG. 4 is an enlarged side view of one of the feed access spouts of FIG. 3 and a cover for the feed access spout.

FIG. 5 is a flow chart illustrating a poultry feeding method.

### DETAILED DESCRIPTION

The following detailed description, which references to and incorporates the drawings, describes and illustrates one or more specific embodiments. These embodiments, offered not to limit but only to exemplify and teach, are shown and described in sufficient detail to enable those skilled in the art to practice what is claimed. Thus, for the sake of brevity, the description may omit certain information known to those of skill in the art.

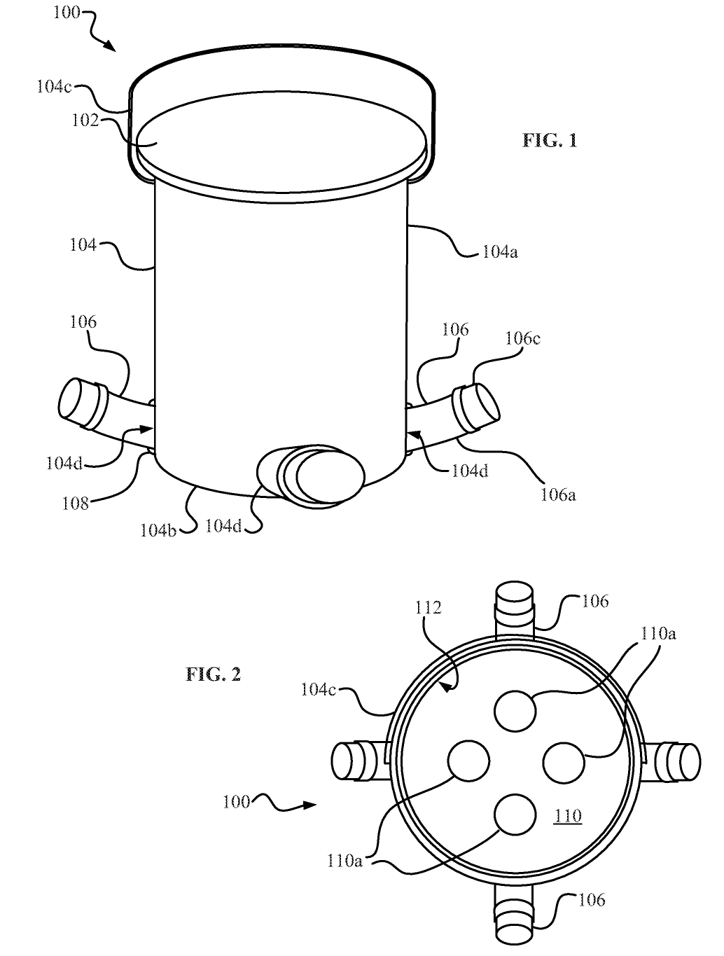

Poultry feeding system and method are provided. FIG. 1 shows of an exemplary poultry feeding system 100. The poultry feeding system 100 may have a lid 102 and a housing 104. The housing 104 may be a bucket, for example, a five gallon bucket. The housing 104 may include a cylindrical portion 104a, a floor portion 104b, a handle 104c, and one or more holes 104d.

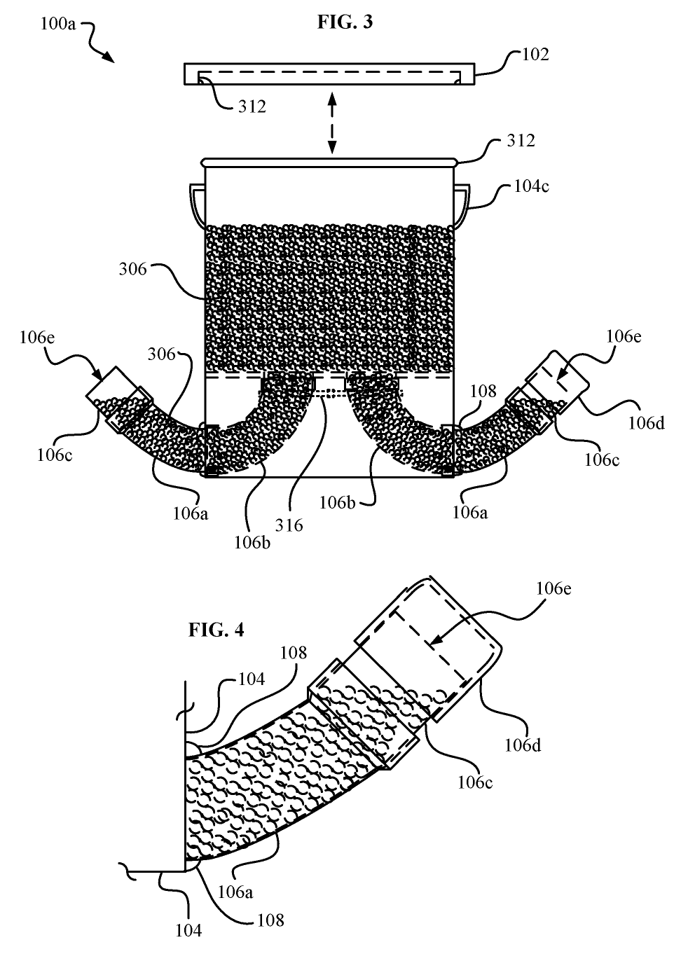

The housing 104 and lid 102 may form a re-sealable locking system, such as, but not limited to, a screw threaded rim at the top of the housing 104, and a corresponding threaded interior lip portion of the lid 102, as is known to those have ordinary skill in the art. The re-sealable locking system may also be a rounded portion 310 (see FIG. 3) on the rim of the housing 104 and a corresponding ridge grip 312 on the interior lip portion of the lid 102.

Protruding through a lower portion of the cylindrical portion 104a may be one or more feed access spouts 106. The feed access spouts 106, may be formed, for example, but not limited to, from a two inch 45 degree PVC street elbow 106a (shown in FIG. 1 and FIG. 3), and a two inch 90 degree PVC standard elbow 106b (shown in FIG. 3), a two inch PVC nipple of two inches in length 106c (shown in FIG. 1 and FIG. 3), and an end cap 106d (shown in FIG. 3). The system 100 may include four of the feed access spouts 106 that may be positioned at 90 degrees around the lower portion of the cylindrical portion 104a of the housing 104. The feed access spouts 106 may be sealed and fixed to the housing 104, for example, but not limited to, through the use of a first caulk seal 108.

FIG. 2 is a top view showing the interior of the housing 104. FIG. 2 illustrates that the system 100 may include a dispersion floor 110. The dispersion floor 110 allows for poultry feed 306 (See FIG. 3) to be partially supported in the housing 104 between the dispersion floor 110 and the top of the feeder housing 104. FIG. 3 shows a side view of second exemplary poultry feeding system 100a. The dispersion floor 110 includes one or more dispersion openings 110a that may allow for feed 306 to flow through gravity from the interior of the housing 104 above the dispersion floor 110, to the feed access spouts 106. The feed access spouts 106 may be positioned, and of sufficient length and height, for the gravity feed to be impeded within the feed access spouts 106 near the end 106e of the feed access spout 106, such that the feed 306 will remain within the feed access spout 106, but shall be available to poultry (not shown) through the extension of the a beek of the poultry into the end 106e of the feed access spouts 106. The dispersion floor 110 may be sealed and fixed to the interior of the housing 104, for example, but not limited to, through the use of a second caulk seal 112.

FIG. 4 shows and end cap 106d that may be included in the feed access spout 106.

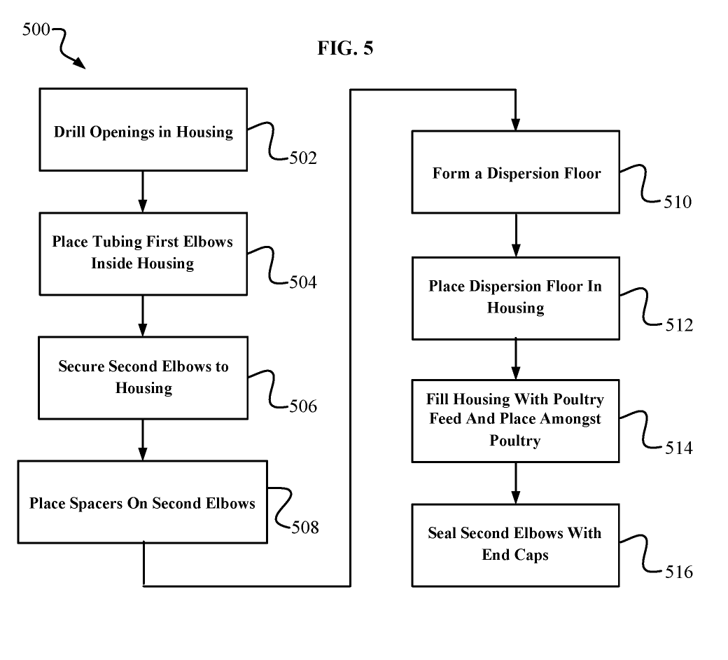

FIG. 5 is a flowchart illustrating an exemplary poultry feeding method 500. The poultry feeding method may include a first step 502 of drilling openings in a housing. Step 502 may include drilling one or more holes in a housing, for example, but not limited to, housing 104. Step 102 may include drilling four holes 104d on the side(s) of a housing 1 ⅝^{th} inch above the bottom of the housing. Step 102 may include deburring the drilled holes to remove unwanted material from the housing.

Method 500 may include a second step 504 of placing first tubing elbows inside the housing such that the first elbows terminate at the openings of Step 502. For example, step 504 may include placing four elbows, such as, but not limited to, four two inch 90 degree PVC standard elbows 106b, such that the elbows terminate on a first elbow end at a dispersion floor, such as dispersion floor 110, and second elbow end at a hole, such as hole 104d. Step 504 may include using ties 316 to position the tubing elbows prior to the placement of a dispersion floor in the housing.

Method 500 may include a third step 506 of securing one or more second elbows to the housing. For example, second step 506 may include securing 45 degree PVC street elbow 106a to housing 104 at the holes of step 502. The second elbows may be secured, for example, through a combination of pressures fitting, by passing a portion of the second elbow through the hole of step 502, where the hole is sized to snuggly fit around the exterior of the 45 degree elbow, and using caulk, such as first caulk seal 108, to secure the second elbow to the exterior of the housing.

Method 500 may include a fourth step 508 of placing spacers on the end of the second elbows of step 506. For example, fourth step 508 may include placing two inch PVC nipples of two inches in length 106c onto the end of 45 degree PVC street elbow 106a. The spacer may be sized to form a pressure fitting to secure the spacer in the second elbow. The spacers may be sufficient length to prevent feed (not shown) that flows by gravity from the housing through the second elbow to come to rest in the spacer, without flowing out of the spacer. Step 508 may include cutting a length of PVC to form the spacer, for example, two-inch PVC, and deburring the spacer to remove unwanted material from the spacer.

Method 500 may include a fifth step 510 of forming a dispersion floor. For example, step 510 may include forming dispersion floor 110. Step 510 may include cutting four circular holes on a circular plastic sheet. The plastic sheet may be formed to have an exterior edge matched to the interior of the housing of step 502. For example, dispersion floor 110 may have a circumference matched to the interior of the housing 104. Step 510 may include cutting one or more holes in the plastic sheet to align with the ends of first elbows placed in second step 504, for example, dispersion openings 110a.

Method 500 may include a sixth step 512 of placing the dispersion floor of step 510 in the housing of step 502. Step 510 may include aligning the holes of step 510 with the centerline of the first elbows of second step 504. For example, step 510 may include placing the dispersion floor 104 into the interior of housing 104. Step 510 may also include sealing and securing the tops of the first elbows to the dispersion floor. For example, step 510 may include gluing the top of the first elbows to the underside of the dispersion floor. Step 510 may further include caulking the exterior of the dispersion floor to the interior of the housing. For example, step 510 may include forming second caulk seal 112.

Method 500 may include a seventh step 514 of filling the housing with poultry feed, for example feed 306, and placing the housing amongst poultry.

Method 500 may include an eighth step 516 of sealing the 45 degree elbows of third step 506 using end caps. For example, eighth step 516 may include placing end cap 106d on 45 degree elbow 106a.

Benefits of the systems and methods disclosed include a no mess feeder, a feeder that fills, for example, thirty pounds, a feeder that may last for weeks, a portable feeder, a feeder that is semi-contamination proof, a feeder that resists mice and migratory birds, a feeder that is constructed from recyclable materials, a feeder that inhibits poultry from fighting over food, a feeder that results in less waste and better balanced meal, a feeder that is easy to clean, a feeder that is gravity operated, and a feeder that is waterproof when inside a coop or covered pen.

The feeding system and method allow for more convenient and efficient provision of feed for generally free roaming poultry. The system may include a sealable feed housing 104, for example, a bucket with a detachable cover, that may have one or more dispersion openings on the lower side(s) of the feed housing that allow a controlled discharge of feed from the bucket, through the dispersion openings, where the feed is then made available to the poultry. The poultry feeding method may include filling a sealable feed housing, sealing the housing, a making feed available at one or more dispersion openings on the lower side(s) of the feed housing. The poultry feeding system and method allow for quickly providing safe and secure feed to poultry through a devise that may be readily constructed from materials that are commonly available and that may be assembled with rudimentary tools.

The word “exemplary” is used herein to mean “serving as an example, instance, or illustration.” Any embodiment or variant described herein as “exemplary” is not necessarily to be construed as preferred or advantageous over other embodiments or variants. All of the embodiments and variants described in this description are exemplary embodiments and variants provided to enable persons skilled in the art to make and use the invention, and not necessarily to limit the scope of legal protection afforded the appended claims.

The above description of the disclosed embodiments is provided to enable any person skilled in the art to make or use that which is defined by the appended claims. The following claims are not intended to be limited to the disclosed embodiments. Other embodiments and modifications will readily occur to those of ordinary skill in the art in view of these teachings. Therefore, the following claims are intended to cover all such embodiments and modifications when viewed in conjunction with the above specification and accompanying drawings.

I claim:

1. A poultry feeding system, comprising:
a bucket;
a lid configured to removably seal the top of the bucket;
a plurality of openings on the side of the bucket; and
a plurality of arced tubing extending from the openings at the bottom past the sides of the bucket.

2. A method of feeding poultry, including the steps of:
drilling an opening in a housing;
placing first elbows in the housing;
securing second elbows to the housing;
placing spacers on the second elbows;
forming a dispersion floor;
placing the dispersion floor in the housing;
filling the housing with feed; and
placing the housing amongst poultry.
